(19) United States
(12) Patent Application Publication
(10) Pub. No.: US 2015/0378843 A1
(43) Pub. Date: Dec. 31, 2015

(54) RESTORATION OF A FILE SYSTEM OBJECT FROM RAW IMAGE BACKUP DATA

(71) Applicant: HEWLETT-PACKARD DEVELOPMENT COMPANY, L.P., W. Houston, TX (US)

(72) Inventors: Mandar Nanivadekar, Bangalore (IN); Rohan A, Kulkarni, Bangalore (IN)

(21) Appl. No.: 14/764,256

(22) PCT Filed: Jan. 29, 2013
(86) PCT No.: PCT/US2013/023542

§ 371 Date: Jul. 29, 2015

(51) Int. Cl. G06F 11/14; G06F 17/30

(52) U.S. Cl. CPC G06F 11/1469; G06F 17/30233; G06F 2201/84

(57) ABSTRACT

In some implementations, blocks of raw image backup data are stored as part of a raw image backup of data in a file system. Blocks of raw image backup data are retrieved from a virtual volume by a restore device, to restore at least one file system object of the file system.

### BACKGROUND

A computer system may store data in a file system, which maintains data in an arrangement of files and directories. The files and directories of a file system can be backed up to a backup storage system to protect the files and directories in case of a fault or other condition that may cause data loss at the computer system.

### BRIEF DESCRIPTION OF THE DRAWINGS

Some embodiments are described with respect to the following figures:

FIG. 1 is a block diagram of an example arrangement that incorporates a backup server according to some implementations;

FIGS. 2A-2B are schematic diagrams of blocks of an example file system;

FIG. 3 is a flow diagram of a process of a backup server according to some implementations

FIG. 4 is a flow diagram of a process of a restore agent according to some implementations; and

FIG. 5 is a block diagram of a system incorporating some implementations.

### DETAILED DESCRIPTION

Data backup can be performed with respect to data stored in a single computer system or in an arrangement of multiple computer systems. The data may be stored in a file system (or multiple file systems). In an arrangement where data is stored in multiple file systems, some of the file systems may be of different types. Examples of computer systems include computer servers, desktop computers, notebook computers, smartphones, and so forth.

Each different file system type can have a different file system structure on persistent storage. A particular type of file system can be mountable in computer systems having different operating systems, as long as the operating systems recognize the particular file system type. For example, a New Technology File System (NTFS) is recognizable by Linux or Windows operating systems.

If a file system is relatively large (in other words, the file system includes a relatively large number of files and directories), a data backup performed to back up the data of the file system may take a relatively long period of time (e.g. hours or days) to complete. A slow backup can reduce computer system performance or performance of a network of servers.

One type of data backup includes a file system backup that backs up the files and directories of the file system. A file system backup can be relatively time consuming, since the backup involves transfer of the underlying data of the file system to a backup storage system, while maintaining the file system structure of files and directories. In the ensuing discussion, files and/or directories of a file system can be generally referred to as “file system objects.”

Another type of data backup includes a raw image backup, in which the underlying data is transferred block by block (as a raw image) to a backup storage system without maintaining the file system structure at the backup storage system. The raw image backup bypasses the file system, and instead accesses a mount point (entry point to the file system) and backs up data from the mount point block by block as raw data. The raw image backup operation can be faster than a file system backup operation, since the amount of time involved in performing the raw image backup operation is independent of the number of file system objects in the file system and can be independent of the type of file system.

Another issue associated with a file system backup is that a catalog has to be created when doing the file system backup. The catalog for the file system backup can include file and directory names, attributes of files and directories, locations of files in storage media, and so forth. As a result, a catalog for a file system backup can consume a relatively large amount of storage space, and also, the amount of time taken to create the catalog can be relatively high and can vary proportionally to the number of file system objects to be cataloged.

In contrast, for a raw image backup, a catalog may be generated asynchronously after the backup is complete or during the backup. In addition, the catalog for a raw image backup can include just a tree structure of the file system and does not contain location information of files.

Since the file system structure is not provided with the raw image backup, performing a restore operation of an individual file system object from the raw image backup data blocks at the backup storage system can be challenging.

In some cases, a file system reverse engineering process can be used when performing a raw image backup of data in a file system. During the raw image backup operation, the file system reverse engineering process creates a mapping of file system objects and raw image backup data blocks that are backed up to the backup storage location. The mapping can be used to restore an individual file system object.

Performing a file system reverse engineering process as part of a raw image backup operation can increase the complexity of the raw image backup operation. For example, different file systems to be backed up can have different file system structures that are to be interpreted as part of the file system reverse engineering process. Also, the file system reverse engineering process may rely on routines that may be unsupported by an entity that provided the file system. As a result, a file system structure produced using such routines may not be correct. Moreover, as new file systems are introduced, code for the file system reverse engineering process may have to be updated, which can lead to further complexity, to increased maintenance costs, or to lengthened product release cycles.

In accordance with some implementations, techniques or mechanisms are provided to perform raw image backup of data in a file system, and to allow for recovery of an individual file system object of the file system from blocks of raw image backup data, without using a file system reverse engineering process. The raw image blocks can be stored on a variety of storage media, including disks, disk arrays, deduplication systems, tape drives, and so forth. Raw image blocks from the same raw image backup can also be split across different types of storage media. The raw image blocks may be stored in a compressed and/or encrypted form. Deduplication can also be applied to avoid storing duplicated copies of blocks.

A backup server can be provided that supports the performance of a raw image backup of data in a file system, and the restoration of individual file system objects from the raw image backup data. Since a file system reverse engineering process is not performed, the backup server does not understand the file system associated with the raw image backup data. Instead, the backup server can generate a virtual volume that contains raw image backup data blocks, where the virtual volume is made accessible to a backup restore device. Based on the virtual volume, the backup restore device is able to restore individual file system objects from the virtual volume by retrieving raw image backup data blocks from the virtual volume that make up the file system object that is to be restored. The backup restore device has the responsibility of identifying the file system from the virtual volume.

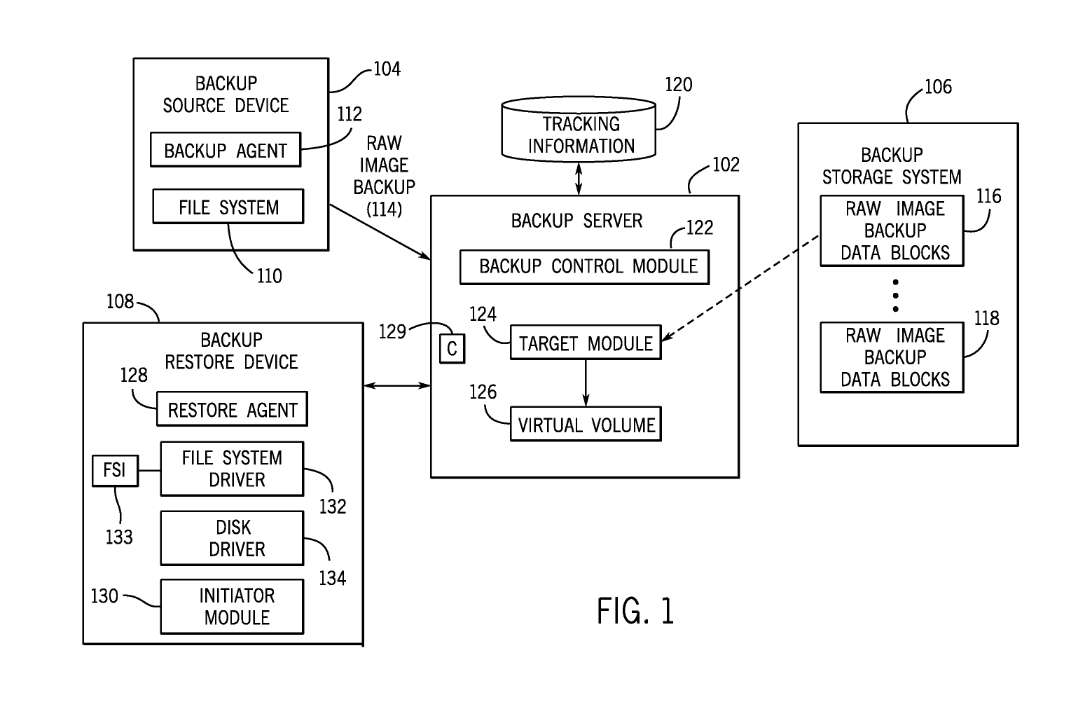

FIG. 1 is a block diagram of an example arrangement that includes a backup server 102 coupled to a backup source device 104, a backup storage system 106, and a backup restore device 108. The backup source device 104 is the device containing data to be backed up, while the backup restore device 108 is the device that is able to request restore of backed up data. Although shown as separate devices, it is noted that in some example arrangements, the backup storage device 104 and the backup restore device 108 may be part of the same device.

Although not depicted in FIG. 1, the backup server 102 can be coupled to the backup source device 104, backup storage system 106, and backup restore device 108 over one or multiple networks, such as a local area networks (LAN), a storage area networks (SAN), a wide area network (WAN), and so forth. Although just one backup source device 104, one backup restore device 108, and one backup storage system 106 are depicted in FIG. 1, it is noted that another example arrangement may include multiple backup source devices, multiple backup restore devices, and/or multiple backup storage systems. Some of the multiple backup source devices may include different types of file systems.

Each of the backup source device 104 and backup restore device 108 can be implemented as any of various different computer systems. Also, the backup server 102 can be implemented as a single computer system, or as multiple computer systems. The backup storage system 106 can be implemented with one or multiple storage devices.

The backup storage device 104 includes a file system 110 containing file system objects (files and directories). The file system 110 can also include component(s) for managing the access of file system objects. Such component(s) can be in the form of machine-readable instructions (that can include software and/or firmware). The file system 110 can also include data structures used for organizing the file system objects. For example, the file system 110 can include a hierarchical tree structure in which the file system objects can be arranged at different hierarchical levels, such as arranging directories and files at various different levels.

The backup source device 104 also includes a backup agent 112, which is able to perform a raw image backup 114 of data in the file system 110 to the backup server 102. In the raw image backup 114, the backup agent 112 bypasses the file system 110, and instead accesses a mount point at which data of the file system 110 is located. A mount point can refer to an entry point to a file system. The file system data is transferred as raw data on a block-by-block basis to cause the blocks of raw image backup data to be transferred to the backup server 102. Transferring a raw image backup data block from the backup source device 104 to the backup server 102 can include copying the raw image backup data block or moving the raw image backup data block. The raw image backup data blocks of the raw image backup 114 can be stored in the backup storage system 106, as collections 116, 118 of raw image backup data blocks. Note that although just one backup storage system 106 is shown in the FIG. 1 example, the raw image backup data blocks of the raw image backup 114 can be split across multiple backup storage systems in other examples.

For improved efficiency, compression or deduplication of the raw image backup data blocks may be performed by the backup server 102. Deduplication refers to avoiding the storage of duplicate data.

Different portions of the file system 110 can be backed up in different raw image backup sessions. For example, a first version of data in the file system 110 can be backed up in a first raw image backup session (which can be a full backup session in which all data in the file system 110 is backed up). When data in the file system 110 is later modified, the backup agent 112 can perform an incremental backup, where just changed data blocks in the file system 110 is backed up in another raw image backup session. The changed data includes data that is different from the last backup. Changes to data in the file system 110 can be due to insertion of a file system object, deletion of a file system object, or modification of a file system object. In the example of FIG. 1, the collection 116 of raw image backup data blocks can correspond to a first raw image backup session, while the collection 118 of raw image backup data blocks can correspond to another raw image backup session.

In some implementations, the backup server 102 maintains a database containing tracking information 120, which can include information associating raw image backup data blocks with respective raw image backup sessions. The backup server 102 is able to use the tracking information 120 to determine which raw image backup session a particular block of data is part of. Thus, when the backup server 102 receives a request for the particular block, the backup server 102 can retrieve raw image backup data blocks from the respective collection stored in the backup storage system 106 that corresponds to the respective raw image backup session.

The database containing the tracking information 120 can be stored in a storage subsystem of the backup server 102, or alternatively, stored on a storage subsystem that is separate from the backup server 102. For example, the database containing the tracking information 120 can be stored in the backup storage system 106.

In some implementations, the tracking information 120 can also associate raw image backup data blocks with respective backup stores of the backup storage system 106. Alternatively, the tracking information 120 can associate the raw image backup data blocks across multiple backup storage systems, such as across a disk array, a deduplication storage system, a tape storage system, and so forth.

In some examples, the backup storage system 106 can be divided into multiple physical backup stores or multiple logical backup stores. Different collections of raw image backup data blocks corresponding to respective raw image backup sessions can be stored in different backup stores of the backup storage system 106. Thus, in some examples, a first backup store of the backup storage system 106 can store the collection 116 of raw image backup data blocks that correspond to a first raw image backup session, and a second backup store of the backup storage system 106 can store the collection 118 of raw image backup data blocks that correspond to a second raw image backup session. By using the tracking information 120 that indicates where in the backup storage system 106 each raw image backup data block is located, the backup server 102 can access the appropriate backup store of the backup storage system 106.

More generally, the tracking information 120 can allow for the identification of locations of respective raw image backup data blocks in the backup storage system 106. In other implementations, instead of associating individual raw image backup data blocks with respective locations in the backup storage system 106, the tracking information 120 can instead associate a group of raw image backup data blocks with respective locations in the backup storage system 106. For example, the group of raw image backup data blocks can include a sector of blocks (in implementations that employ disk-based storage), a cluster of blocks, or any other grouping of blocks.

The tracking information 120 can also include other information. For example, the tracking information 120 can identify the backup source device that is being backed up, the type of file system that is being backed up, and so forth.

The backup server 102 includes a backup control module 122 that is able to store raw image backup data blocks received from the backup source device 104 in the backup storage system 106. The backup control module 122 can also create the tracking information 120 as part of each raw image backup operation.

The backup server 102 further includes a target module 124, which is able to present (make accessible) a virtual volume 126 that contains raw image backup data blocks retrieved by the backup control module 122 from the backup storage system 106. The virtual volume 126 is generated by the backup control module 122 by retrieving the respective raw image backup data blocks and including the retrieved raw image backup data blocks in the virtual volume 126. The retrieved respective blocks can include blocks from a particular raw image backup session (full or incremental or both); additionally, the retrieved respective blocks can include blocks from a number incremental backup sessions and one full backup session, which may be combined virtually to construct the virtual volume based on the respective file which is to be restored.

The virtual volume 126 can be presented (made accessible) to the backup restore device 108, which is able to restore individual file system objects based on the raw image backup data blocks contained in the virtual volume 126. Note that presenting a virtual volume does not have to involve the transfer of all of the blocks of a raw image backup. Rather, the raw image backup data blocks are transferred on demand. Note that a mechanism can be provided to make the virtual volume 126 read-only, in some examples.

The virtual volume 126 differs from a file system volume (e.g. C:\ volume, D;\ volume, etc.), since the blocks of the virtual volume 126 can reside anywhere in any storage, and the blocks of the virtual volume 126 may be compressed, encrypted, and/or deduplicated. When a particular block of the virtual volume 126 is requested, such as by the backup restore device 108, that block can be extracted from the relevant storage and decompressed, decrypted, and/or un-deduplicated and provided to the requester. Note that deduplication can be different for different systems from different vendors—the backup server 102 can be configured to be familiar with the different deduplication approaches.

The backup server 102 does not attempt to decode file system objects corresponding to the raw image backup data blocks in the virtual volume 126.

The backup restore device 108 is able to transfer raw image backup data blocks from the virtual volume 126. Based on the transferred raw image backup data blocks, a restore agent 128 in the backup restore device 108 is able to restore at least one individual file system object.

It is noted that the virtual volume 126 can include raw image backup data blocks for a particular raw image backup session. In some examples, multiple virtual volumes can be presented by the target module 124 for multiple raw image backup sessions.

In other examples, multiple backups (including a full backup and one or multiple incremental backups of respective raw image backup sessions) can be consolidated and stored as a single raw backup image, which can be presented as a respective virtual volume. The full backup and incremental backup(s) can be combined to create a final backup image that is related to a version or view of a file system at a particular point in time. If deduplication is applied, performing the foregoing consolidation may not take up much additional storage space.

The backup restore device 108 further includes an initiator module 130 that is able to cooperate with the target module 124 to retrieve raw image backup data blocks from the virtual volume 126 to allow the restore agent 128 to restore individual file system object(s). During a restore operation, the initiator module 130 can send commands to the target module 124 to retrieve identified raw image backup data blocks from the virtual volume 126 for use in restoring at least one individual file system object. During a restore operation, the initiator module 130 and target module 124 communicate so that the initiator module identifies the respective virtual volume from the target module.

In some examples, the initiator module 130 can be an Internet Small Computer System Interface (iSCSI) initiator module, and the target module 124 in the backup server 102 can be an iSCSI target. An iSCSI initiator can send a SCSI command to an iSCSI target, to perform a data access operation. In the arrangement of FIG. 1, the data access operation is performed with respect to the virtual volume 126 presented by the iSCSI target. A description of iSCSI can be found in Request for Comments (RFC) 3720, entitled “Internet Small Computer Systems Interface (iSCSI),” dated April 2004.

In other examples, the initiator module 130 and target module 124 are modules related to performing Fibre Channel communications. Fibre Channel provides a relatively high-speed network technology used for storage networking. The standards for Fibre Channel are provided by the International Committee for Information Technology Standards (INCITS). In the context of a Fibre Channel environment, the initiator module 130 is able to send Fibre Channel commands to the target module 124 to perform data access operations with respect to the virtual volume 126. The virtual volume 126 can be a Fibre Channel logical unit identified by a logical unit number (LUN).

The backup restore device 108 further includes a file system driver 132 and a disk driver 134. The file system driver 132 can be provisioned with file system information 133 to allow the file system driver 132 to understand the file system 110 of the backup source device 104.

The disk driver 134 can work in conjunction with the file system driver 132 to obtain blocks related to the file system object(s) to be restored. The file system driver 132 knows which raw image backup data blocks are to be retrieved for restoring a particular file system object. The file system driver 132 requests these blocks from the disk driver 134, which in turn causes the initiator module 130 to send commands to the target module 124 for retrieving the desired blocks. Although referenced as a “disk driver,” it is noted that in alternative implementations, the driver 134 can operate with storage devices other than disk-based storage devices. In addition, although depicted as multiple modules, it is noted that the restore agent 128, file system driver 132, disk driver 134, and initiator module 130 in the backup restore device 108 can be integrated into fewer modules. Similarly, the backup control module 122 and the target module 124 in the backup server 102 can be integrated into one module.

The backup restore device 108 can also access a catalog 129 stored at the backup server 102 or at another storage location. The catalog 129 can include a list of files and directories of a volume. The catalog 129 can be accessed and used by the restore agent 128 to present, to a user or other entity, file system objects that can be restored. The user or other entity can select the file system object(s) to restore. There can be one catalog created per full or incremental backup session.

The catalog 129 may or may not be created at raw image backup time. If the catalog 129 does not exist, then during a restore operation, the restore agent 128 can itself perform the scan on the virtual volume 126 and show the list of file system objects contained in the virtual volume 126 to allow the user or other entity to select the file system objects to restore.

In accordance with some implementations, rather than configuring the backup server 102 with information to allow the backup server 102 to understand the file system, the backup restore device 108 is provided with the file system information 133 pertaining to the file system 110. As a result, the backup restore device 108 is configured to identify file system objects from the virtual volume 126 presented by the backup server 102. The retrieval of raw image backup data blocks for the identified file system objects can be a relatively simple operation using a communication protocol such as iSCSI or Fibre Channel, as discussed above.

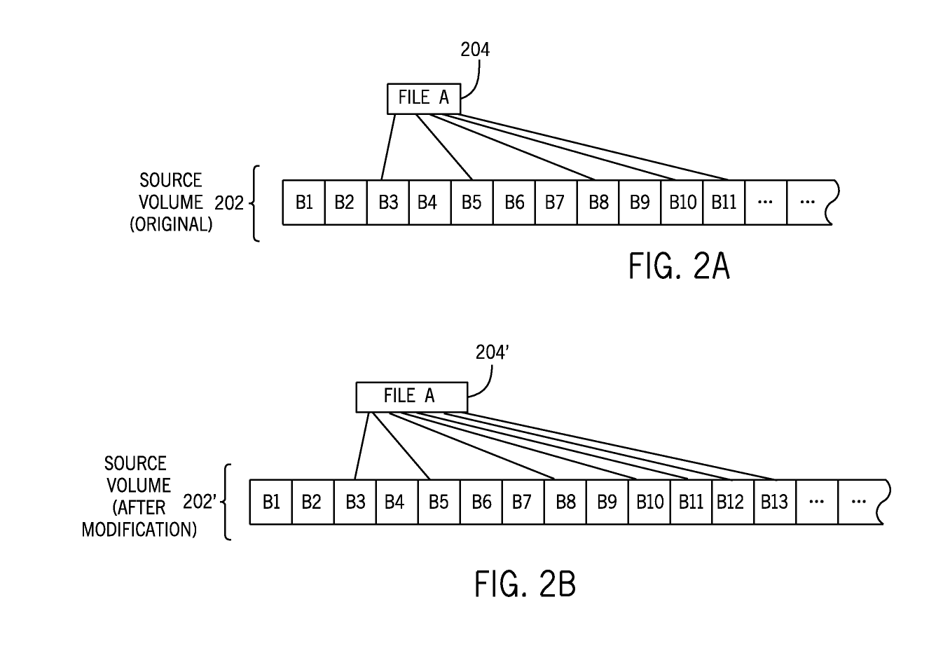

FIGS. 2A-2B illustrate blocks 202 of a source volume that is part of the file system 110 of FIG. 1. For example, the source volume can be the C:\ volume. Each block is identified by a Bi label (where i=1, 2 . . . ). In FIG. 2A, blocks B1-B11 are shown. In the example of FIG. 2A, a particular file, file A (204), includes blocks B3, B5, B8, B10, and B11. The source volume of FIG. 2A shows the source volume at some point in time. In an example, it is assumed that the blocks 202 of the source volume of FIG. 2A can be backed up to the backup server 102 of FIG. 1 in a full raw image backup session (where all of the blocks of the source volume are transferred to the backup server 102).

FIG. 2B shows the source volume after a modification has been made. The modified source volume includes blocks 202′. In the example of FIG. 2B, it is assumed that file A has been modified, where modified file A is referenced as 204′. In the example of FIG. 2B, file A has been modified by adding two blocks B12 and B13.

An incremental raw image backup session can be performed with respect to the blocks 202′, which backs up of just blocks B12 and B13 to the backup storage system 106 (since blocks B1-B11 remain unchanged).

To restore the latest version of file A, each of the following blocks would have to be retrieved (such as by using the catalog 129 in the backup server 102): B3, B5, B8, B10, B11, B12, and B13. To do so, the backup server 102 would have to retrieve raw image backup data blocks from two raw image backup sessions (the full backup session and the incremental backup session). For example, the catalog for a full backup may show that file A, file B, and file C have been backed up. The catalog for incremental backup may show that only file A has been backed up. During restore, the user may be shown two versions of file A: file A (from the full backup), and file A (from the incremental backup).

Based on the version to be restored, the virtual volume 126 can be constructed using the tracking information 120 to fetch blocks of the full and incremental backups.

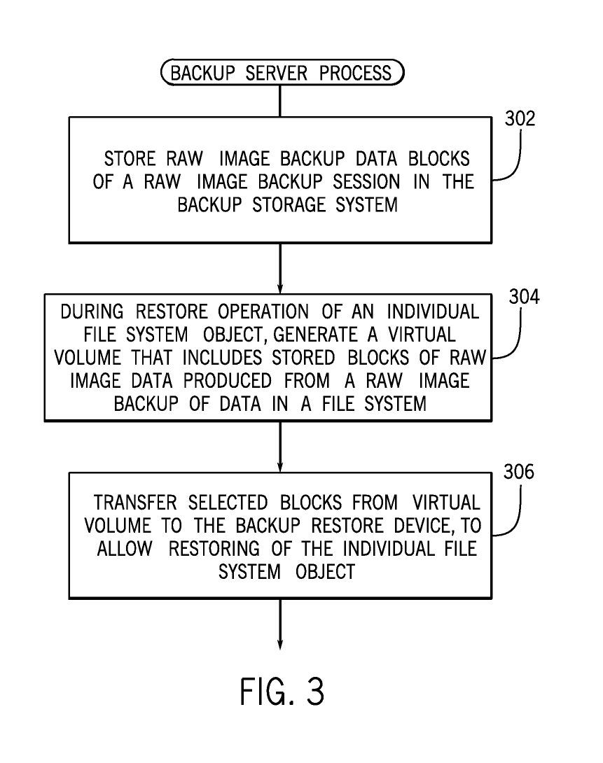

FIG. 3 is a flow diagram of a process according to some implementations. The process can be performed by the backup server 102, in accordance with some implementations. For example, the process can be performed by the backup control module 122 and/or target module 124 of the backup server 102.

During a raw image backup session, the backup server 102 receives raw image backup data blocks from the backup source device 104 and stores (at 302) the raw image backup data blocks into the backup storage system 106.

A restore operation for restoring an individual file system object can be initiated by the backup restore device 108. During the restore operation, the backup server 102 can generate (at 304) the virtual volume 126 that includes stored blocks of raw image data retrieved from the backup storage system 106 and that were produced from a raw image backup of data in a file system. The virtual volume 126 is presented to be visible (accessible) to the backup restore device 108.

The backup server 102 can then transfer (at 206) selected blocks from the virtual volume 126 to the backup restore device 108, as part of the restore operation. The transfer of the selected blocks from the virtual volume 126 to the backup restore device 108 can be in response to commands received by the target module 124 in the backup server 102 from the initiator module 130 in the backup restore device 108. The transferred blocks received by the backup restore device 108 can be used to restore at least one file system object at the backup restore device 108.

In some examples, the blocks of the virtual volume 126 to be transferred can be decided by the file system driver 132 of the backup restore device 108 of FIG. 1. The restore agent 128 in the backup restore device 108 sees a file on the virtual volume 126. Then the restore agent 128 can start copying the file using the file system's application programming interface (API). The API can perform a call to the file system driver 132, which will decide which blocks to fetch. The initiator module 130 then gets a call to fetch a block that is returned by the target module 124.

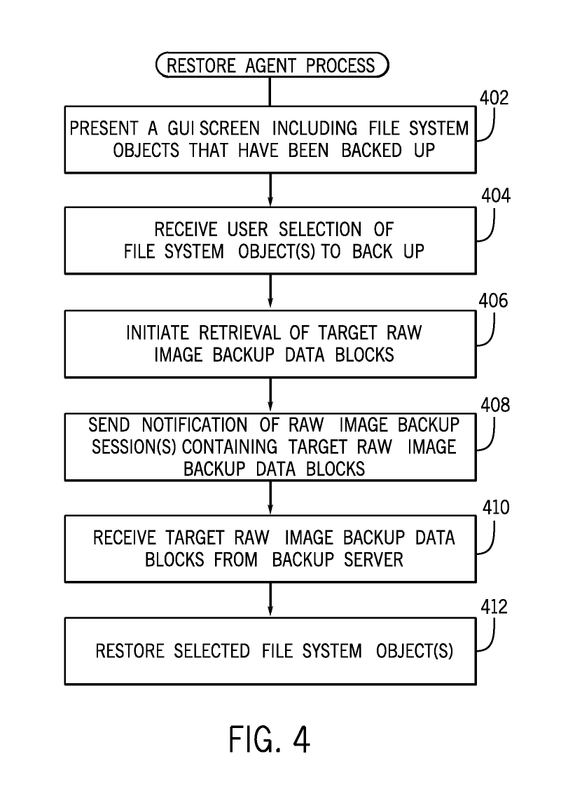

FIG. 4 is a flow diagram of a restore process that can be performed by the restore agent 128 in the backup restore device 108, in accordance with some implementations. The restore agent 128 can present (at 402) a graphical user interface (GUI) screen to present file system objects that have been backed up to the backup storage system 106. The content of the GUI screen is based on the catalog 129, which was created by the backup agent 112 during performance of a raw image backup. The catalog 129 can store various information, including at least some combination of the following information relating to file system objects that have been backed up: name of a file system object, size of a file system object, attributes of a file system object, timestamps of a file system object (such as a timestamp indicating when a file system object was created, a timestamp indicating when a file system object was modified, and a timestamp indicating when a file system object was accessed), and so forth. The content of the catalog 129 can be created by performing a file system scan during the raw image backup operation.

A user at the backup restore device 108 can select file system object(s) to back up by making selections in the GUI screen. The restore agent 128 receives (at 404) user selection of file system object(s) that is (are) to be restored. In other examples, instead of a user selecting file system object(s) to select, a selection can be made by another entity, such as an application or a machine.

Upon receiving the selection of the file system object(s) to restore, the restore agent 128 can initiate (at 406) the retrieval of the raw image backup data blocks that are to be used for restoring the selected file system object(s). As part of task 406, the restore agent 128 can interact with the file system driver 132 to identify raw image backup data blocks that are to be retrieved for restoring the selected file system object(s).

The restore agent 128 sends (at 408) notification, through the initiator module 130, to the backup server 102 that raw image backup data blocks relating to a particular raw image backup session (or multiple raw image backup sessions) are to be retrieved. The notification can include one or multiple messages sent from the restore agent 128 to the backup control module 122 in the backup server 102. In response to the notification from the restore agent 128, the backup control module 122 presents one or multiple virtual volumes that contains respective raw image backup data blocks from the backup storage system 106.

The restore agent 128 can then send commands (through the initiator module 130) to the target module 124 in the backup server for target raw image backup data blocks to be used for restoring the selected file system object(s). The restore agent 128 receives (at 410) the target raw image backup data blocks from the backup server 102. The selected file system object(s) is (are) restored (at 412) based on the received target raw image backup data blocks.

In some cases, the restore agent 128 does not ask for all blocks pertaining to the selected file system object(s) to be retrieved from the backup server 102 at one time. Initially, the restore agent 128 can cause the initiator module 130 to ask for a few first few blocks. These first few blocks can include a storage partition table along with some other information. A storage partition table can be created at the time of a raw image backup. For example, the storage partition table can identify respective partitions, such as volumes C:, D:, and E:, as examples. In addition, the storage partition table can store the host type (type of backup source device) as well as the partition table type (the partition table type can be different for different types of operating systems) for each raw image backup session identified in the tracking information 120.

These first few blocks are retrieved by the backup server 102, and returned back to the restore agent 128. After that, the restore agent 128 can work with the file system driver 132 to identify the blocks for each file system object to be restored. The file system driver 132 can send a request to the disk driver 134 for the desired blocks. The disk driver 134 can in turn ask the initiator module 130 to obtain the blocks from the target module 124 in the backup server 102.

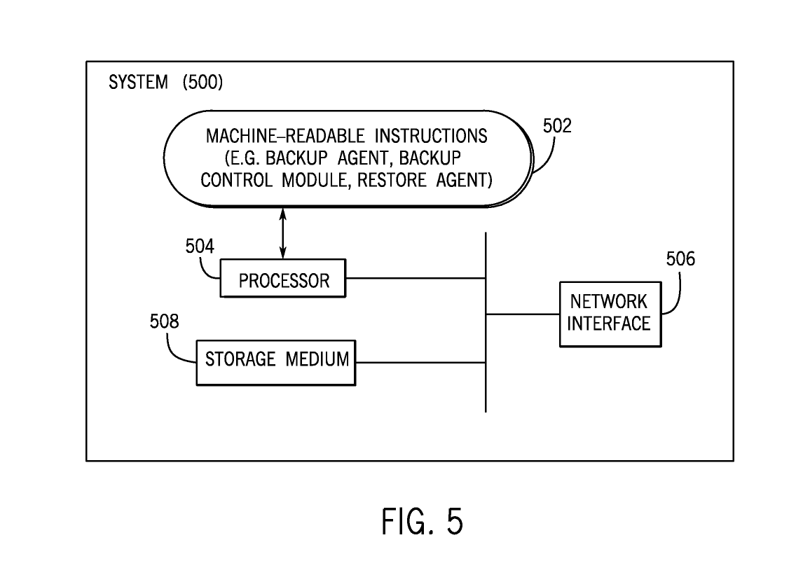

FIG. 5 is a block diagram of an example system 500, which can be any one of the backup storage device 104, backup server 102, and backup restore device 108, of FIG. 1. The system 500 includes machine-readable instructions 502, which can include any one of the backup agent 112, backup control module 122, and restore agent 128 of FIG. 1. The machine-readable instructions 502 are executable on one or multiple processors 504.

A processor can include a microprocessor, microcontroller, processor module or subsystem, programmable integrated circuit, programmable gate array, or another control or computing device. The processor(s) 504 can be coupled to the network interface 506 to allow the system 500 to communicate over a network, and to a storage medium (or storage media) 508.

The storage medium (or storage media) 508 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
during a restore operation initiated by a restore device, generating, by a server, a virtual volume that includes stored blocks of raw image backup data produced from a raw image backup of data in a file system, wherein the virtual volume is accessible to the restore device; and
transferring selected blocks of the blocks of raw image backup data in the virtual volume to the restore device, as part of the restore operation in which the restore device is to restore at least one file system object of the file system using the selected blocks.

2. The method of claim 1, further comprising:
accessing, by the server, tracking information that associates groups of blocks of raw image backup data with respective raw image backup sessions,
wherein the blocks of raw image backup data are from at least one of the raw image backup sessions identified as corresponding to the restore operation.

3. The method of claim 2, wherein the tracking information further identifies storage locations of the blocks of the raw image backup data.

4. The method of claim 1, wherein the server is configured to be without information to allow the server to understand the file system.

5. The method of claim 1, wherein the server presents the virtual volume using a Internet Small Computer System Interface (iSCSI) target, and wherein the transferring is from the iSCSI target to an iSCSI initiator at the restore device.

6. The method of claim 1, wherein the server presents the virtual volume as a Fibre Channel logical unit, and wherein the transferring uses Fibre Channel communications.

7. The method of claim 1, further comprising:
storing, by the server, tracking information that associates the blocks of raw image backup data with storage locations in a backup storage system,
the virtual volume is generated using the tracking information.

8. The method of claim 1, wherein the virtual volume is generated in response to a request from the restore device.

9. The method of claim 8, wherein transferring the selected blocks to the restore device comprises transferring the selected blocks to the restore device that is configured to understand the file system.

10. A backup restore device comprising:
at least one processor; and
a restore agent executable on the at least one processor to:
receive selection of at least one file system object of a file system to restore;
send, to a backup server, information pertaining to raw image backup data blocks of the at least one file system object, wherein the raw image backup data blocks were backed up from the file system to the backup server as part of a raw image backup;
receive the raw image backup data blocks from a virtual volume made available by the backup server; and
restore the at least one file system object using the received raw image backup data blocks.

11. The backup restore device of claim 10, further comprising an initiator module to interact with a target module of the backup server to transfer raw image backup data blocks from the virtual volume to the backup restore device.

12. The backup restore device of claim 11, wherein the initiator module includes an Internet Small Computer System Interface (iSCSI) initiator, and the target module includes an iSCSI target.

13. The backup restore device of claim 11, wherein the initiator module is to perform a Fibre Channel communication with the target module, and wherein the virtual volume is a logical unit identified by a logical unit number.

14. The backup restore device of claim 10, further comprising a file system driver configured to understand the file system, wherein the restore agent is to cooperate with the file system driver to retrieve the raw image backup data blocks to use for restoring the at least one file system object.

15. An article comprising at least one machine-readable storage medium storing instructions that upon execution cause a backup server to:
during a restore operation initiated by a restore device, generate a virtual volume that includes stored blocks of raw image backup data produced from a raw image backup of data in a file system, wherein the virtual volume is accessible to the restore device; and
transfer selected blocks of the blocks of raw image backup data in the virtual volume to the restore device, as part of the restore operation in which the restore device is to restore at least one file system object of the file system using the selected blocks.
